(19) United States
(12) Patent Application Publication
(10) Pub. No.: US 2010/0245498 A1
(43) Pub. Date: Sep. 30, 2010

(54) FLUID SUPPLYING APPARATUS, FLUID EJECTING APPARATUS, AND FLUID SUPPLYING METHOD

(75) Inventors: Yoshihiro KOIZUMI, Shiojiri-shi (JP); Hideya YOKOUCHI, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/729,457

(22) Filed: Mar. 23, 2010

(30) Foreign Application Priority Data
Mar. 26, 2009 (JP) 2009-075812

(51) Int. Cl. B41J 2/175; F04B 43/02

(52) U.S. Cl. 347/85; 417/53; 417/472

(57) ABSTRACT

A fluid supplying apparatus includes a fluid supplying passage through which fluid is supplied from a fluid supplying source, at an upstream side, toward a downstream side. A pump includes a pump chamber and a first displacement portion. A closing device closes the fluid supplying passage and includes a pressure chamber and a second displacement portion. The second displacement portion is displaced to increase or decrease capacity of the pressure chamber. The second displacement portion is displaced in a direction for decreasing the capacity of the pressure chamber in accordance with negative pressure that is applied from the downstream side of the fluid supplying passage to close the fluid supplying passage. A pressure reduction chamber is formed next to the pressure chamber and is partitioned from the pressure chamber. An opening device opens the fluid supplying passage and reduces internal pressure of the pressure reduction chamber.

This application claims the benefit of Japanese Patent Application No. 2009-075812, filed Mar. 26, 2009, which is expressly incorporated herein by reference in its entirety.

### BACKGROUND

1. Technical Field

The present invention relates to a fluid supplying apparatus, a fluid ejecting apparatus, and a fluid supplying method.

2. Related Art

An ink-jet printer is widely known as an example of a fluid ejecting apparatus that ejects fluid onto a target medium. An ink-jet printer ejects ink (fluid) supplied to a recording head (fluid ejecting head) through nozzles, which are formed in the recording head, onto a recording target medium, which is an ejection target, thereby performing printing on the target. As an example of such a printer, a printer that includes a pump that is provided somewhere on an ink flow passage (fluid supplying passage) has been proposed in the art as disclosed in JP-A-2006-272661. The ink flow passage is a fluid channel through which an ink cartridge (fluid supplying source) is in communication with a recording head. The pump applies pressure for supplying ink from the ink cartridge to the recording head.

Specifically, a part of the ink flow passage of the printer disclosed in JP-A-2006-272661 is formed as a pump chamber. Suction operation for increasing the capacity of the pump chamber and pump-discharging operation (i.e., pumping-out operation) for decreasing the capacity of the pump chamber are repeated for supplying ink to the recording head intermittently.

In the operation of such a printer, there is a risk of poor printing that is caused by the clogging of nozzles that occurs because of an increase in the viscosity of ink due to the evaporation of ink solvent through the nozzles of a recording head or caused by missing dots due to the formation of air bubbles in ink.

As a method for overcoming the problem of nozzle clogging and the like, printers of late have a function for implementing a so-called choke cleaning method as disclosed in JP-A-2002-355992. Specifically, cleaning is performed as follows. Negative pressure is applied inside an ink flow passage from a recording-head side through nozzles. Because of the negative pressure, a film that is provided somewhere on the ink flow passage is displaced to close the ink flow passage. As a result, negative pressure accumulates in the recording head. Thereafter, ink is supplied from an ink cartridge to displace the film in a direction for opening the ink flow passage. As ink flows to the downstream side rapidly with a great force, ink having increased viscosity and/or air bubbles trapped in the recording head is/are forcibly discharged out of the recording head.

In a type of printers that supplies ink to a recording head intermittently through pumping operation, the amount of ink that can be supplied as a result of a single pump-discharging operation is limited. For this reason, in order to supply ink whose amount is sufficiently large for choke cleaning, it is necessary to perform suction operations and pump-discharging operations more than once. However, with intermittent supply of ink, the negative pressure of the ink flow passage is gradually released at each time of pump-discharging operation. Because of the gradual negative pressure release, there is a problem in that it is difficult to perform choke cleaning effectively.

To address this difficulty, it is conceivable to adopt a pump whose change in the capacity of a pump chamber is large as a solution for supplying a large amount of ink in a single pump-discharging operation. However, when a large pump is mounted, there is another problem in that the size of an apparatus is inevitably large.

### SUMMARY

An advantage of some aspects of the invention is to provide a fluid supplying apparatus, a fluid ejecting apparatus, and a fluid supplying method that make it possible for fluid to flow from the upstream side of a fluid supplying passage to the downstream side thereof continuously in accordance with negative pressure that is applied from the downstream side without an increase in the size of the apparatus.

In order to address the above-identified problems without any limitation thereto, a fluid supplying apparatus according to a first aspect of the invention includes: a fluid supplying passage through which fluid is supplied from a fluid supplying source, which is provided at an upstream side, toward a downstream side; a pump that is driven for pumping operation, the pump including a pump chamber and a first displacement portion, the pump chamber being formed as a part of the fluid supplying passage, the first displacement portion being able to become displaced in such a way as to increase or decrease capacity of the pump chamber to drive the pump; a closing device that closes the fluid supplying passage, the closing device including a pressure chamber and a second displacement portion, the pressure chamber being formed as a part of the fluid supplying passage at a downstream position viewed from the pump chamber, the second displacement portion being able to become displaced in such a way as to increase or decrease capacity of the pressure chamber, the second displacement portion being displaced in a direction for decreasing the capacity of the pressure chamber in accordance with negative pressure that is applied from the downstream side of the fluid supplying passage to close the fluid supplying passage; a pressure reduction chamber that is formed next to the pressure chamber and is partitioned from the pressure chamber with the second displacement portion being formed as a partition between the pressure reduction chamber and the pressure chamber; and an opening device that opens the fluid supplying passage, the opening device reducing internal pressure of the pressure reduction chamber, the opening device applying negative pressure to the second displacement portion as a result of pressure reduction to cause the second displacement portion to be displaced in a direction for increasing the capacity of the pressure chamber to open the fluid supplying passage.

With such a configuration, with the application of negative pressure to the second displacement portion, which closes the fluid supplying passage, to cause the displacement of the second displacement portion, it is possible to open the fluid supplying passage to keep a state in which fluid can flow. By this means, when negative pressure is applied from the downstream side of the fluid supplying passage, it is possible to make fluid flow continuously from the fluid-supplying-source side without driving the pump. Therefore, it is possible to make a sufficient amount of fluid flow continuously without using a large pump whose amount of fluid that can be supplied as a result of a single pump-discharging operation is large. That is, it is possible to make fluid flow from the upstream side of the fluid supplying passage to the downstream side of the fluid supplying passage continuously in accordance with negative pressure that is applied from the downstream side of the fluid supplying passage without an increase in the size of the apparatus.

In the configuration of a fluid supplying apparatus according to the first aspect of the invention, it is preferable that the pump should further include a variable pressure chamber that is formed next to the pump chamber and is partitioned from the pump chamber with the first displacement portion being formed as a partition between the variable pressure chamber and the pump chamber; and the opening device should reduce internal pressure of the variable pressure chamber to cause the first displacement portion to be displaced in a direction for increasing the capacity of the pump chamber to suck the fluid into the pump chamber, which is suction operation of the pump.

In such a preferred configuration, the opening device reduces the internal pressure of the variable pressure chamber, which is formed next to the pump chamber and is partitioned from the pump chamber with the first displacement portion being formed as a partition between the variable pressure chamber and the pump chamber. When the internal pressure of the variable pressure chamber is reduced, the first displacement portion becomes displaced. Utilizing the displacement of the first displacement portion, the pump performs suction operation. That is, the opening device can be used as a driving source for the suction operation of the pump, which contributes to a reduction in the size of the apparatus.

In the preferred configuration of a fluid supplying apparatus, it is preferable that the opening device should reduce the internal pressure of the variable pressure chamber through a first flow passage through which the opening device is connected to the variable pressure chamber; the opening device should reduce the internal pressure of the pressure reduction chamber through a second flow passage through which the opening device is connected to the pressure reduction chamber; and flow passage resistance of the second flow passage should be larger than that of the first flow passage.

In such a preferred configuration, when the opening device starts to reduce pressure through the first flow passage and the second flow passage at the same time, the internal pressure of the pressure reduction chamber, which is in communication with the second flow passage having a relatively large flow passage resistance, is not reduced concurrently with the reduction of the pressure of the variable pressure chamber, which is in communication with the first flow passage having a relatively small flow passage resistance, but reduced with a certain delay. Since the reduction of the pressure of the pressure reduction chamber is delayed, it is possible to cause the second displacement portion to become displaced after the application of negative pressure to the first displacement portion for the displacement of the first displacement portion in a direction for increasing the capacity of the pump chamber. Therefore, a fluid flow space is secured inside the pump chamber, which is provided at an upstream position, prior to the opening of the fluid supplying passage by the opening device. Thus, it is possible to make fluid flow rapidly with a great force at the time of the opening of the fluid supplying passage due to negative pressure that is applied from the downstream side of the fluid supplying passage.

A fluid ejecting apparatus according to a second aspect of the invention includes a fluid ejecting head that ejects fluid; and the fluid supplying apparatus according to the first aspect of the invention, which supplies the fluid from the fluid supplying source (from the fluid-supplying-source side) toward the fluid ejecting head.

The second displacement portion closes the fluid supplying passage in accordance with negative pressure that is applied from the fluid-ejecting-head side. After the accumulation of a sufficient negative pressure at the downstream side viewed from the second displacement portion, the opening device causes the second displacement portion to be displaced, thereby opening the fluid supplying passage. By this means, it is possible to make fluid flow continuously. Therefore, it is possible to perform choke cleaning for discharging air bubbles or the like out of the fluid ejecting head without using a large pump whose amount of fluid that can be supplied as a result of a single pump-discharging operation is large. That is, it is possible to make fluid flow from the upstream side of the fluid supplying passage to the downstream side of the fluid supplying passage continuously in accordance with negative pressure that is applied from the downstream side of the fluid supplying passage without an increase in the size of the apparatus.

A fluid supplying method according to a third aspect of the invention is a method for supplying fluid through a fluid supplying passage from a fluid supplying source, which is provided at an upstream side, toward a downstream side. The fluid is supplied as a result of operation of a pump that includes a pump chamber and a first displacement portion. The pump chamber is formed as a part of the fluid supplying passage. The first displacement portion can become displaced in such a way as to increase or decrease capacity of the pump chamber to drive the pump. The fluid supplying method according to the third aspect of the invention includes: closing the fluid supplying passage as a result of operation of a pressure chamber and a second displacement portion, the pressure chamber being formed as a part of the fluid supplying passage at a downstream position viewed from the pump chamber, the second displacement portion being able to become displaced in such a way as to increase or decrease capacity of the pressure chamber, the second displacement portion being displaced in a direction for decreasing the capacity of the pressure chamber in accordance with negative pressure that is applied from the downstream side of the fluid supplying passage to close the fluid supplying passage; and opening the fluid supplying passage by reducing internal pressure of a pressure reduction chamber that is formed next to the pressure chamber and is partitioned from the pressure chamber with the second displacement portion being formed as a partition between the pressure reduction chamber and the pressure chamber and applying negative pressure to the second displacement portion as a result of pressure reduction to cause the second displacement portion to be displaced in a direction for increasing the capacity of the pressure chamber while suppressing the displacement of the first displacement portion in a direction for increasing the capacity of the pump chamber to open the fluid supplying passage.

Besides the working effects as those of the fluid supplying apparatus described above, a fluid supplying method according to the third aspect of the invention produces the following advantageous effects. At the time of the opening of the fluid supplying passage, since the displacement of the first displacement portion in a direction for increasing the capacity of the pump chamber is suppressed, the pump is not driven for suction when fluid flows due to negative pressure that is applied from the downstream side of the fluid supplying passage. Thus, it is possible to make fluid flow rapidly with a great force at the time of the opening of the fluid supplying passage due to negative pressure that is applied from the downstream side of the fluid supplying passage.

### BRIEF DESCRIPTION OF THE DRAWINGS

The invention will be described with reference to the accompanying drawings, wherein like numbers reference like elements.

FIG. 1 is a diagram that schematically illustrates an example of the configuration of an ink-jet printer according to an exemplary embodiment of the invention.

FIG. 2A is a diagram that schematically illustrates an example of an operation state of an ink supplying apparatus according to an exemplary embodiment of the invention at the time of pump-suction driving operation.

FIG. 2B is a diagram that schematically illustrates an example of an operation state of an ink supplying apparatus according to an exemplary embodiment of the invention at the time of pump-discharging driving operation.

FIG. 3A is a diagram that schematically illustrates an example of an operation state of an ink supplying apparatus according to an exemplary embodiment of the invention before starting choke cleaning.

FIG. 3B is a diagram that schematically illustrates an example of an operation state of an ink supplying apparatus according to an exemplary embodiment of the invention at the time of starting choke cleaning.

FIG. 4A is a diagram that schematically illustrates an example of an operation state of an ink supplying apparatus according to an exemplary embodiment of the invention, where the internal pressure of a first air chamber is reduced before the reduction of the internal pressure of a second air chamber.

FIG. 4B is a diagram that schematically illustrates an example of an operation state of an ink supplying apparatus according to an exemplary embodiment of the invention, where an ink flow passage is opened in choke cleaning.

### DESCRIPTION OF EXEMPLARY EMBODIMENTS

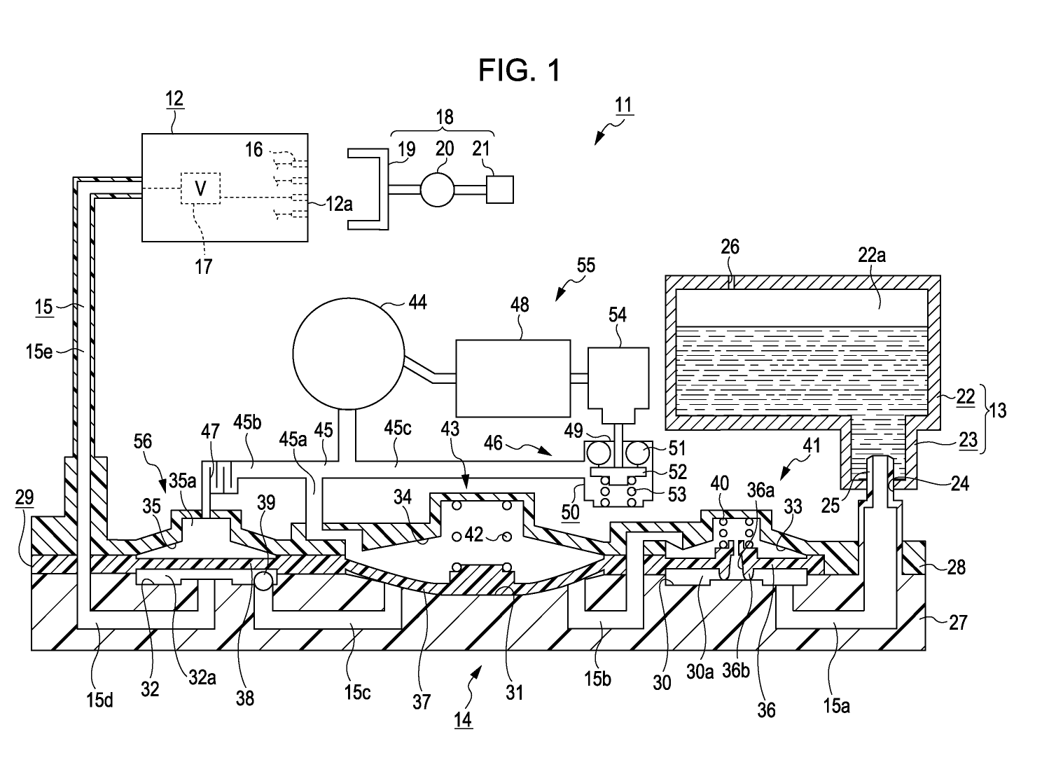

With reference to FIGS. 1 to 4, an ink-jet recording apparatus, which is a kind of a fluid ejecting apparatus according to an exemplary embodiment of the invention, will now be explained in detail. An ink-jet recording apparatus is hereinafter referred to as a printer. As illustrated in FIG. 1, a printer 11 according to the present embodiment of the invention is provided with a recording head 12, which is an example of a fluid ejecting head, and an ink supplying apparatus 14, which is an example of a fluid supplying apparatus. The recording head 12 ejects ink, which is an example of fluid, onto a target medium. The target medium is not illustrated in the drawing. The ink supplying apparatus 14 supplies ink that is contained in an ink cartridge 13 to the recording head 12. The ink cartridge 13 is an example of a fluid supplying source. An ink flow passage 15 is formed inside the ink supplying apparatus 14. The upstream end of the ink flow passage 15 is connected to the ink cartridge 13. The downstream end of the ink flow passage 15 is connected to the recording head 12. Ink is supplied through the ink flow passage 15 from the ink cartridge 13, that is, from the upstream side, to the recording head 12, that is, to the downstream side. The ink flow passage 15 is an example of a fluid supplying passage.

The printer 11 is provided with a plurality of ink supplying apparatuses 14. The number of the ink supplying apparatuses 14 corresponds to the number of colors (types) of ink used for printing. The structure of the ink supplying apparatus 14 corresponding to each ink color is the same as those of the others. Therefore, a single ink supplying apparatus 14 that corresponds to one ink color only is shown in FIG. 1. Besides the ink supplying apparatus 14, the recording head 12 and the ink cartridge 13 that contains ink of the corresponding one color are shown in FIG. 1. In the following description, the supplying of ink by the single ink supplying apparatus 14 shown in FIG. 1 from the ink cartridge 13 to the recording head 12 through the ink flow passage 15 is explained as an example.

As illustrated in FIG. 1, a plurality of nozzle orifices (i.e., nozzle holes) 16 is formed through a nozzle formation surface 12a of the recording head 12. The recording head 12 can eject ink from the plurality of nozzle orifices 16. A valve unit 17 is built in the recording head 12. The valve unit 17 includes a flow pressure adjustment mechanism for supplying ink stably. With the supplying of ink whose amount depends on the amount of ink consumption, the flow pressure of ink is adjusted.

The printer 11 is provided with a maintenance unit 18. The maintenance unit 18 performs maintenance operation such as cleaning or the like on the recording head 12. The maintenance unit 18 includes a cap member 19, a suction pump 20, and a waste ink tank 21. The cap member 19 can be brought into contact with the nozzle formation surface 12a of the recording head 12 so as to enclose the nozzle orifices 16 as a covering cap. The suction pump 20 is driven to generate negative pressure inside the cap member 19. When the suction pump 20 is driven, ink is sucked out of the recording head 12. The waste ink tank 21 is a container for the sucked ink. For example, after the completion of printing or at other appropriate timing, the cap member 19 is moved from the position illustrated in FIG. 1 to be brought into contact with the recording head 12. Then, the suction pump 20 is driven in this cap contact state to generate negative pressure in an inner space of the cap member 19. As a result, ink that has increased viscosity and/or ink that contains air bubbles is/are drained out of the recording head 12 into the waste ink tank 21 due to a suction force. Cleaning is performed in this way.

The ink cartridge 13 includes a case 22 that has a box-like shape. An ink chamber 22a is formed inside the case 22. Ink is contained in the ink chamber 22a of the case 22. A cylinder portion 23 protrudes from the bottom of the case 22. The cylinder portion 23 is in communication with the ink chamber 22a. An ink supplying port 24 is formed at the tip of the cylinder portion 23. Ink contained in the ink cartridge 13 can flow out through the ink supplying port 24.

When the ink cartridge 13 is attached to the ink supplying apparatus 14, an ink supply needle 25 is inserted into the ink supplying port 24. The ink supply needle 25 protrudes from the ink supplying apparatus 14. The ink supply needle 25 constitutes the upstream end of the ink flow passage 15. An air communication hole 26 is formed through the top wall of the case 22. The ink chamber 22a in which ink is contained is opened to the outside air through the air communication hole 26. Accordingly, atmospheric pressure is applied to the surface of the ink contained in the ink chamber 22a.

Next, the configuration of the ink supplying apparatus 14 is explained in detail below. As illustrated in FIG. 1, the ink supplying apparatus 14 includes a first flow passage formation member 27, a second flow passage formation member 28, and a flexible member 29. The first flow passage formation member 27 is a base member that is made of resin. The second flow passage formation member 28 is also made of resin. The second flow passage formation member 28 is fixed as an upper layer over the first flow passage formation member 27, which is a base lower layer. The flexible member 29 is sandwiched between the first flow passage formation member 27 and the second flow passage formation member 28 when these members 27 and 28 are put together. The material of the flexible member 29 is, for example, a rubber plate.

Concave portions 30, 31, and 32 are formed in one surface of the first flow passage formation member 27 (i.e., the upper surface thereof in FIG. 1). Each of the concave portions 30, 31, and 32 has the shape of a circle in a plan view. On the other hand, concave portions 33, 34, and 35 are formed in one surface of the second flow passage formation member 28 (i.e., the lower surface thereof in FIG. 1). Each of the concave portions 33, 34, and 35 also has the shape of a circle in a plan view. The concave portion 33 is formed opposite to the concave portion 30. The concave portion 34 is formed opposite to the concave portion 31. The concave portion 35 is formed opposite to the concave portion 32.

The flexible member 29 is sandwiched between the first flow passage formation member 27 and the second flow passage formation member 28 as a partition between the concave portions 30, 31, and 32 of the first flow passage formation member 27 and the concave portions 33, 34, and 35 of the second flow passage formation member 28, respectively. A portion of the flexible member 29 that is interposed between the concave portion 30 and the concave portion 33 functions as a valve portion (i.e., valve) 36. The valve portion 36 can become deformed elastically between the concave portion 30 and the concave portion 33 to cause elastic displacement (i.e., change in position caused by elastic deformation).

A through hole 36a is formed at the center of the valve portion 36. Therefore, the concave portion 30 and the concave portion 33 are in communication with each other through the through hole 36a. A space that is surrounded by the concave portion 30 and the concave portion 33 is a valve chamber 30a.

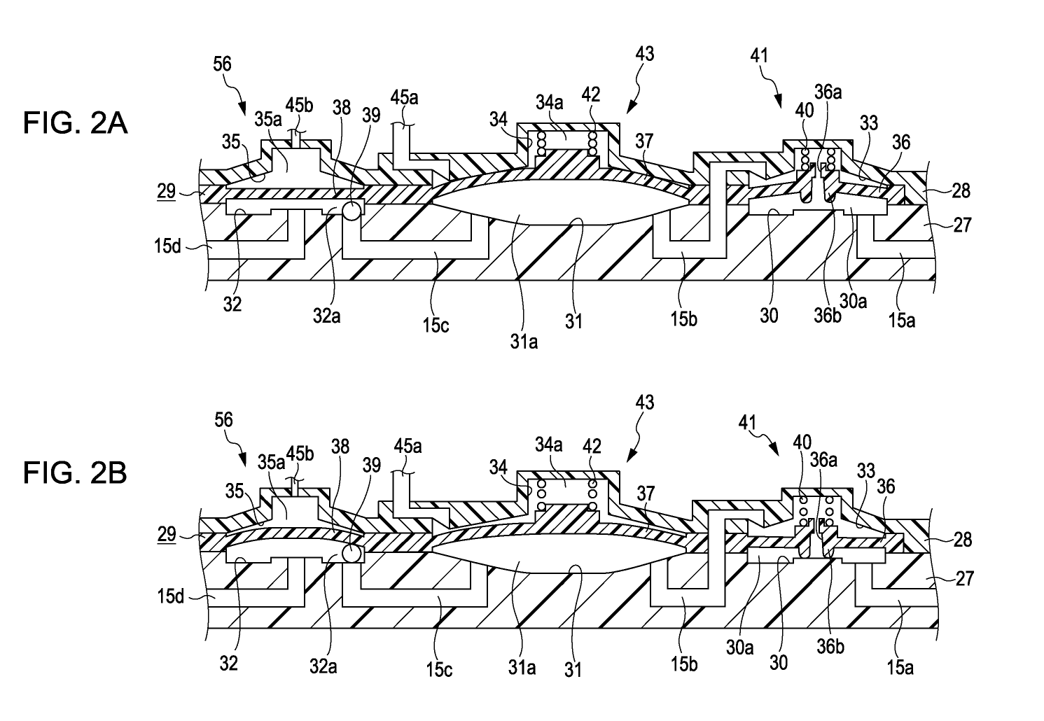

A portion of the flexible member 29 that is interposed between the concave portion 31 and the concave portion 34 functions as a first displacement portion 37. The first displacement portion 37 can become displaced in such a way as to increase/decrease the capacity of the concave portions 31 and 34. A space that is surrounded by the first displacement portion 37 and the concave portion 31 is a pump chamber 31a (refer to FIG. 2), which constitutes a part of the ink flow passage 15. On the other hand, a space that is surrounded by the first displacement portion 37 and the concave portion 34 is a first air chamber 34a. The first air chamber 34a is an example of a variable pressure chamber (i.e., pressure change chamber).

A portion of the flexible member 29 that is interposed between the concave portion 32 and the concave portion 35 functions as a second displacement portion 38. The second displacement portion 38 can become displaced in such a way as to increase/decrease the capacity of the concave portions 32 and 35. A space that is surrounded by the second displacement portion 38 and the concave portion 32 is a pressure chamber 32a, which constitutes another part of the ink flow passage 15. On the other hand, a space that is surrounded by the second displacement portion 38 and the concave portion 35 is a second air chamber 35a. The second air chamber 35a is an example of a pressure reduction chamber.

Ink flow passages 15a, 15b, 15c, and 15d are formed inside the layered structure that includes the first flow passage formation member 27, the second flow passage formation member 28, and the flexible member 29. The ink flow passages 15a, 15b, 15c, and 15d make up a continuous ink flow passage that leads from the ink supply needle 25, which is the upstream end of the continuous ink flow passage, to the recording head 12, which is connected to the downstream end thereof. In FIG. 1, the ink flow passages 15a, 15b, 15c, and 15d are arranged in this order as viewed from the right to the left.

The ink supply needle 25, which protrudes through the second flow passage formation member 28, is formed on the first flow passage formation member 27. The ink flow passage 15a through which the needle tip side of the ink supply needle 25 and the concave portion 30 are in communication with each other is formed inside the first flow passage formation member 27. The concave portion 33 and the concave portion 31 are in communication with each other through the ink flow passage 15b. The concave portion 31 and the concave portion 32 are in communication with each other through the ink flow passage 15c. The upstream end of the ink flow passage 15d is in communication with the concave portion 32. One end of an ink supplying tube 15e (i.e., the upstream end thereof) is connected to the downstream end of the ink flow passage 15d. The other end of the ink supplying tube 15e (i.e., the downstream end thereof) is connected to the recording head 12.

That is, the ink supply needle 25, the ink flow passage 15a, the valve chamber 30a, the ink flow passage 15b, the pump chamber 31a, the ink flow passage 15c, the pressure chamber 32a, the ink flow passage 15d, and the ink supplying tube 15e, which are arranged in the order of appearance herein as viewed from the upstream side toward the downstream side, make up the ink flow passage 15 of the ink supplying apparatus 14.

A ball valve 39 is provided at the downstream end of the ink flow passage 15c, which is in communication with the pressure chamber 32a. The ball valve 39 acts as a one-way valve that allows ink to pass therethrough only in a direction from the upstream side to the downstream side. An urging member that is not illustrated in the drawing applies an urging force to the ball valve 39. Therefore, the ball valve 39 is constantly urged in a valve-closing direction, that is, in a direction for closing the ink flow passage 15c.

A coil spring 40 is provided inside the concave portion 33 of the valve chamber 30a. The coil spring 40 applies an urging force to the valve portion 36. Therefore, the valve portion 36 is constantly urged toward the concave portion 30. The valve portion 36 has a projection 36b. The projection 36b can be brought into contact with the inner bottom surface of the concave portion 30 to get into a valve-closed state. The valve portion 36 is constantly urged in a valve-closing direction by the coil spring 40. In the present embodiment of the invention, the valve chamber 30a, the valve portion 36, and the coil spring 40 make up a one-way valve 41, which allows ink to pass therethrough only in a direction from the upstream side to the downstream side.

A coil spring 42 is provided in the first air chamber 34a. The coil spring 42 applies an urging force to the first displacement portion 37. Accordingly, the first displacement portion 37 is constantly urged in a direction for decreasing the capacity of the pump chamber 31a. In the present embodiment of the invention, the pump chamber 31a, the first air chamber 34a, the first displacement portion 37, and the coil spring 42 make up a pulsating pump 43. The first displacement portion 37, which can become elastically displaced in such a way as to increase or decrease the capacity of the pump chamber 31a, becomes displaced in accordance with a change in the pressure of the first air chamber 34a, which is formed next to the pump chamber 31a and is partitioned from the pump chamber 31a with the first displacement portion 37 being formed as a partition between the first air chamber 34a and the pump chamber 31a. The pump 43 performs pumping with the elastic displacement of the first displacement portion 37.

The one-way valve 41 is provided on the ink flow passage 15 at an upstream position viewed from the pump chamber 31a. In addition, the ball valve 39, which is another one-way valve, is provided on the ink flow passage 15 at a downstream position viewed from the pump chamber 31a. With the upstream one-way valve 41 and the downstream one-way valve 39, ink does not flow backward from the downstream side to the upstream side when the pump 43 is operated.

When a negative pressure generation device 44 reduces the internal pressure of the first air chamber 34a, the first displacement portion 37 becomes elastically displaced in a direction for increasing the capacity of the pump chamber 31a. As the capacity of the pump chamber 31a increases, ink is sucked into the pump chamber 31a. The pump 43 according to the present embodiment of the invention performs suction operation in this way.

The negative pressure generation device 44 is connected to the first air chamber 34a through an airflow passage 45. Specifically, the base end of the airflow passage 45 is connected to the negative pressure generation device 44. The front-end side of the airflow passage 45 branches into three passages, which are branch airflow passages 45a, 45b, and 45c. The branch airflow passage 45a is connected to the first air chamber 34a. The branch airflow passage 45a is an example of a first flow passage.

The branch airflow passage 45b is connected to the second air chamber 35a. The branch airflow passage 45b is an example of a second flow passage. The branch airflow passage 45c is connected to an air opening mechanism 46. A flow passage extension portion 47 is formed as a part of the branch airflow passage 45b, which is connected to the second air chamber 35a. The flow passage extension portion 47 is a meandering flow passage that is formed so as to ensure that the flow-passage resistance of the branch airflow passage 45b is larger than that of the branch airflow passage 45a.

A driving motor 48 is a motor that can turn in the normal direction and in the reverse direction selectively. When the driving motor 48 turns in the normal direction, the negative pressure generation device 44 is driven to generate negative pressure due to driving power. The driving power is transmitted to the negative pressure generation device 44 through a one-way clutch, which is not illustrated in the drawing. Therefore, as a result of the turning of the driving motor 48 in the normal direction, the internal pressure of the first air chamber 34a and the internal pressure of the second air chamber 35a are reduced through the airflow passage 45.

As the internal pressure of the first air chamber 34a is reduced, the first displacement portion 37 becomes elastically displaced in a direction for increasing the capacity of the pump chamber 31a. In addition, as the internal pressure of the second air chamber 35a is reduced, the second displacement portion 38 becomes elastically displaced in a direction for increasing the capacity of the pressure chamber 32a. Since the flow-passage resistance of the branch airflow passage 45b, which includes the flow passage extension portion 47, is larger than that of the branch airflow passage 45a, the second displacement portion 38 becomes elastically displaced after the elastic displacement of the first displacement portion 37.

The air opening mechanism 46 includes an air open hole 49, a box 50, a sealing member 51, an air open valve 52, and a coil spring 53. The air open valve 52 is provided inside the box 50, which has the air open hole 49. The sealing member 51 is provided inside the box 50 at the air-open-hole (49) side. The coil spring 53, which is also provided inside the box 50, applies an urging force to the air open valve 52. Therefore, the air open valve 52 is constantly urged in a valve-closing direction, which is a direction for sealing the air open hole 49, by the coil spring 53. When the driving motor 48 turns in the reverse direction, driving power is transmitted to a cam mechanism 54 through a one-way clutch, which causes the cam mechanism 54 to operate. As a result of the operation of the cam mechanism 54, the air open valve 52 of the air opening mechanism 46 operates in a valve-opening direction against the urging force that is applied thereto by the coil spring 53. In the present embodiment of the invention, the negative pressure generation device 44, the airflow passage 45, the second air chamber 35a, the air opening mechanism 46, the driving motor 48, and the cam mechanism 54 make up an opening means 55.

Therefore, when the driving motor 48 turns in the reverse direction after turning in the normal direction, the air open valve 52 operates in the valve-opening direction to open the airflow passage 45 to the outside air. Since the airflow passage 45 is opened to air, the negative-pressure state of the first air chamber 34a and the negative-pressure state of the second air chamber 35a are released.

When the negative-pressure state of the first air chamber 34a is released, the first displacement portion 37 becomes elastically displaced in a direction for decreasing the capacity of the pump chamber 31a because of an urging force that is applied thereto by the coil spring 42. That is, the pump 43 performs suction operation to suck ink into the pump chamber 31a from the upstream side when the internal pressure of the first air chamber 34a is reduced. Triggered by the opening of the first air chamber 34a to air, the pump 43 performs discharging operation to pump ink out of the pump chamber 31a to the downstream side due to the urging force that is applied by the coil spring 42.

When the pump chamber 31a is in a suction-driven state, negative pressure is generated in the pump chamber 31a. Because of the negative pressure generated in the pump chamber 31a, the ball valve 39, which is provided at a downstream position, is closed whereas the one-way valve 41, which is provided at an upstream position, is opened against an urging force that is applied by the coil spring 40. When the pump chamber 31a is in a discharge-driven state, positive pressure is generated in the pump chamber 31a. Because of the positive pressure generated in the pump chamber 31a, the ball valve 39 provided at the downstream position is opened whereas the one-way valve 41 provided at the upstream position is closed.

Therefore, as a result of the repetition of the suction operation of the pump 43 and the discharging operation thereof in an alternate manner with the ink cartridge 13 being connected to the ink supply needle 25, ink is supplied intermittently from the ink cartridge 13 toward the recording head 12, which consumes ink.

Next, the action of the printer 11, which has the above configuration, is explained below with a focus on the action of the ink supplying apparatus 14. FIG. 1 shows a state immediately after the replacement of the ink cartridges 13. The state shown in FIG. 1 is as follows. The valve portion 36 of the one-way valve 41 is pressed against the inner bottom surface of the concave portion 30 due to an urging force that is applied thereto by the coil spring 40. The first displacement portion 37 of the pump 43 is pressed against the inner bottom surface of the concave portion 31 due to an urging force that is applied thereto by the coil spring 42. The ball valve 39 is set in a closed position due to an urging force that is applied thereto by the aforementioned urging member. The air open valve 52 of the air opening mechanism 46 is set in a closed state to seal the air open hole 49.

With reference to FIG. 2A, suction operation of the pump 43 is explained first. The pump 43 starts suction operation from the initial state of FIG. 1, which is explained above. As a first step, the driving motor 48 turns in the normal direction for driving the pump 43. As the driving motor 48 turns in the normal direction, the negative pressure generation device 44 generates negative pressure. As a result, the first air chamber 34a, which is connected to the negative pressure generation device 44 through the airflow passage 45 (i.e., the branch airflow passage 45a), gets into a negative-pressure state.

Therefore, as illustrated in FIG. 2A, the first displacement portion 37 becomes elastically displaced toward the first air chamber 34a against an urging force that is applied thereto by the coil spring 42. For this reason, the capacity of the first air chamber 34a decreases. As the capacity of the first air chamber 34a decreases, the capacity of the pump chamber 31a, which is formed next to the first air chamber 34a and is partitioned from the first air chamber 34a by the first displacement portion 37, increases. Since the capacity of the pump chamber 31a increases, ink is sucked into the pump chamber 31a. At this moment, negative pressure has not yet been generated in the second air chamber 35a, which is in communication with the branch airflow passage 45b having a relatively large flow-passage resistance. For this reason, the second displacement portion 38 has not become elastically displaced yet.

Next, with reference to FIG. 2B, discharging operation of the pump 43 is explained below. The driving motor 48 turns in the reverse direction for the discharging operation of the pump 43. As the driving motor 48 turns in the reverse direction, the cam mechanism 54 operates, which causes the air open valve 52 of the air opening mechanism 46 to operate in a valve-opening direction against an urging force that is applied thereto by the coil spring 53. As a result, the negative-pressure state of the first air chamber 34a is released.

Therefore, as illustrated in FIG. 2B, the first displacement portion 37 of the pump 43 becomes elastically displaced toward the inner bottom surface of the concave portion 31 because of an urging force that is applied thereto by the coil spring 42, thereby increasing the capacity of the first air chamber 34a. As the capacity of the first air chamber 34a increases, the capacity of the pump chamber 31a, which is formed next to the first air chamber 34a and is partitioned from the first air chamber 34a by the first displacement portion 37, decreases. Since the capacity of the pump chamber 31a decreases, ink is pumped out of the pump chamber 31a. At this moment, discharging pressure of the pump 43 acts on the second displacement portion 38. Therefore, the second displacement portion 38 is elastically displaced toward the second air chamber 35a.

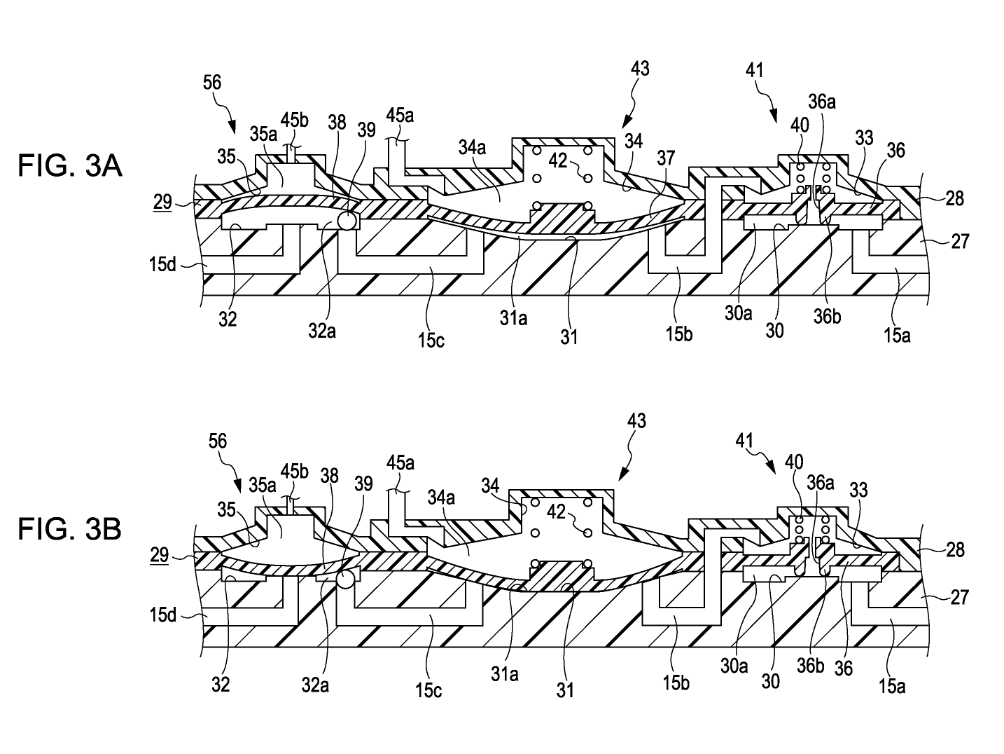

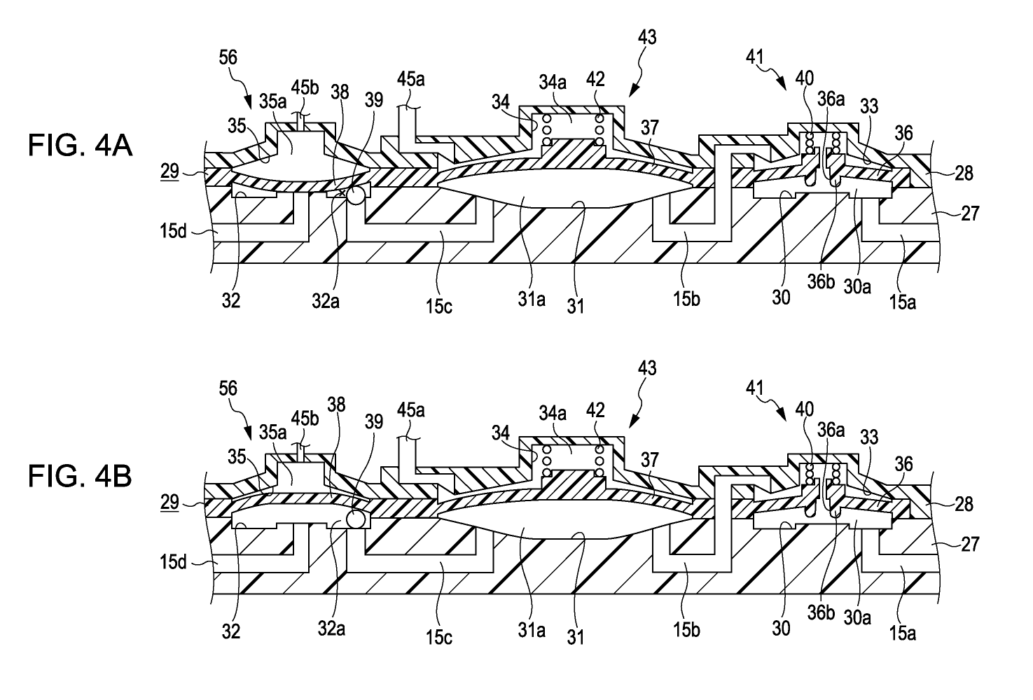

Next, so-called choke cleaning, which is performed by the printer 11 having the configuration explained above for the purpose of, for example, unclogging the nozzle orifices 16, is explained below with reference to FIGS. 3 and 4.

In this specification, choke cleaning means the following cleaning. The suction pump 20 applies a suction force to the recording head 12 in a choked state, which is a state in which a choke valve that is provided somewhere on the ink flow passage 15 is closed. A high negative pressure accumulates at the downstream side viewed from the choke valve due to suction. In this high negative pressure state, the choke valve is opened for the purpose of cleaning. Since ink flows rapidly with a great force due to such a high negative pressure accumulated thereat, choke cleaning makes it possible to effectively discharge ink having increased viscosity and/or air bubbles that is/are difficult to be discharged successfully by means of a normal cleaning method.

In the present embodiment of the invention, the pressure chamber 32a and the second displacement portion 38, both of which are provided at a downstream position viewed from the pump chamber 31a, make up a closing means 56. The closing means 56 functions as a choke valve.

Choke cleaning is usually carried out after print processing performed for a certain time period. Therefore, with reference to FIG. 3A, a state in which the driving of the pump 43 is stopped is explained first as a preliminary step before the execution of choke cleaning.

The air open valve 52 is opened after suction operation when stopping the driving of the pump 43. As a result of the opening of the air open valve 52, positive pressure acts in the pump chamber 31a due to an urging force that is applied by the coil spring 42. Therefore, as illustrated in FIG. 3A, the one-way valve 41 gets into a valve-closed state. In addition, the second displacement portion 38 is elastically displaced toward the second air chamber 35a.

Next, as a closing step, the suction pump 20 is operated in a capped state, that is, after the movement of the cap member 19 so that the cap member 19 is brought into contact with the nozzle formation surface 12a of the recording head 12. Since the suction pump 20 is operated in such a capped state, negative pressure is applied from the downstream side of the ink flow passage 15, which causes a reduction in the internal pressure of the pressure chamber 32a. As a result, the second displacement portion 38 becomes elastically displaced in a direction for decreasing the capacity of the pressure chamber 32a to be brought into contact with the inner bottom surface of the concave portion 32 as illustrated in FIG. 3B. Therefore, the upstream-end opening of the ink flow passage 15d closes. When the internal pressure of the pressure chamber 32a is reduced, negative pressure acts also on the ink flow passage 15c, the pump chamber 31a, and the like. For this reason, the first displacement portion 37 becomes elastically displaced to the bottom dead point (i.e., position).

The driving of the suction pump 20 is continued for a certain time period so as to accumulate a sufficient negative pressure at the downstream side viewed from the second displacement portion 38. Next, as an opening step, the driving motor 48 turns in the normal direction in order to open the upstream-end opening of the ink flow passage 15d.

As the driving motor 48 turns in the normal direction, the negative pressure generation device 44 generates negative pressure. As a result, the first air chamber 34a gets into a negative-pressure state. Accordingly, as illustrated in FIG. 4A, the first displacement portion 37 becomes elastically displaced toward the first air chamber 34a against an urging force that is applied thereto by the coil spring 42. Therefore, the one-way valve 41 is opened. In this valve-open state, ink is sucked into the pump chamber 31a.

Then, at a point in time at which the elastic displacement of the first displacement portion 37 in a direction for increasing the capacity of the pump chamber 31a has almost completed with the completion of suction operation of the pump 43, negative pressure acts also on the second air chamber 35a after acting on the first air chamber 34a. As a result, the second displacement portion 38 becomes elastically displaced in a direction for increasing the capacity of the pressure chamber 32a as illustrated in FIG. 4B. Therefore, the upstream-end opening of the ink flow passage 15d opens. As explained above, since a choked state is forcibly released with the elastic displacement of the first displacement portion 37 being suppressed, ink flows rapidly with a great force from the ink cartridge 13 into the cap member 19 due to accumulated negative pressure. In this way, the ink flow passage 15 and the recording head 12 are cleaned.

If the pressure of the first air chamber 34a and the pressure of the second air chamber 35a were reduced at the same time, or if the pressure of the second air chamber 35a were reduced before the reduction of the pressure of the first air chamber 34a, it might not be possible to secure a sufficient flow space inside the pump chamber 31a in the opening step. In addition, for example, if suction operation of the pump 43 were performed in a state in which the upstream-end opening of the ink flow passage 15d is opened to cause the internal pressure of the pump chamber 31a to become lower than that of the pressure chamber 32a, the flow of ink might be blocked by the ball valve 39 that gets into a valve-closed state. To avoid the above risks, the flow passage extension portion 47 is formed as a part of the branch airflow passage 45b of the ink supplying apparatus 14 according to the present embodiment of the invention. With a difference between the flow-passage resistance of the branch airflow passage 45b and the flow-passage resistance of the branch airflow passage 45a, it is possible to make ink flow while suppressing the elastic displacement of the first displacement portion 37 in a direction for increasing the capacity of the pump chamber 31a.

The printer 11 according to the present embodiment of the invention explained above offers the following advantages.

(1) With the application of negative pressure to the second displacement portion 38, which closes the ink flow passage 15, to cause the elastic displacement of the second displacement portion 38, it is possible to open the ink flow passage 15 to keep a state in which ink can flow. By this means, when negative pressure is applied from the downstream side of the ink flow passage 15, it is possible to make ink flow continuously from the ink-cartridge (13) side without driving the pump 43. Therefore, it is possible to make a sufficient amount of ink flow continuously without using a large pump whose amount of ink that can be supplied as a result of a single pump-discharging operation is large. That is, it is possible to make ink flow from the upstream side of the ink flow passage 15 to the downstream side of the ink flow passage 15 continuously in accordance with negative pressure that is applied from the downstream side of the ink flow passage 15 without an increase in the size of the ink supplying apparatus 14.

(2) The opening means 55 reduces the internal pressure of the first air chamber 34a, which is formed next to the pump chamber 31a and is partitioned from the pump chamber 31a with the first displacement portion 37 being formed as a partition between the first air chamber 34a and the pump chamber 31a. When the internal pressure of the first air chamber 34a is reduced, the first displacement portion 37 becomes elastically displaced. Utilizing the elastic displacement of the first displacement portion 37, the pump 43 performs suction operation. That is, the opening means 55 can be used as a driving source for the suction operation of the pump 43, which contributes to a reduction in the size of the apparatus.

(3) When the opening means 55 starts to reduce pressure through the airflow passage 45, the internal pressure of the second air chamber 35a, which is in communication with the branch airflow passage 45b having a relatively large flow-passage resistance, is not reduced concurrently with the reduction of the pressure of the first air chamber 34a, which is in communication with the branch airflow passage 45a having a relatively small flow-passage resistance, but reduced with a certain delay. Since the reduction of the pressure of the second air chamber 35a is delayed, it is possible to cause the second displacement portion 38 to become elastically displaced after the application of negative pressure to the first displacement portion 37 for the elastic displacement of the first displacement portion 37 in a direction for increasing the capacity of the pump chamber 31a. Therefore, an ink flow space is secured inside the pump chamber 31a, which is provided at an upstream position, prior to the opening of the ink flow passage 15 by the opening means 55. Thus, it is possible to make ink flow rapidly with a great force at the time of the opening of the ink flow passage 15 due to negative pressure that is applied from the downstream side of the ink flow passage 15.

(4) The second displacement portion 38 closes the ink flow passage 15 in accordance with negative pressure that is applied from the recording-head (12) side. After the accumulation of a sufficient negative pressure at the downstream side viewed from the second displacement portion 38, the opening means 55 causes the second displacement portion 38 to be displaced elastically, thereby opening the ink flow passage 15. By this means, it is possible to make ink flow continuously. Therefore, it is possible to perform choke cleaning for discharging air bubbles or the like out of the recording head 12 without using a large pump whose amount of ink that can be supplied as a result of a single pump-discharging operation is large. That is, it is possible to make ink flow from the upstream side of the ink flow passage 15 to the downstream side of the ink flow passage 15 continuously in accordance with negative pressure that is applied from the downstream side of the ink flow passage 15 without an increase in the size of the printer 11.

(5) At the time of the opening of the ink flow passage 15, since the elastic displacement of the first displacement portion 37 in a direction for increasing the capacity of the pump chamber 31a is suppressed, the pump 43 is not driven for suction when ink flows due to negative pressure that is applied from the downstream side of the ink flow passage 15. For this reason, it is possible to prevent the flow of ink from being blocked by the ball valve 39 that gets into a valve-closed state, which would occur if suction operation of the pump 43 were performed in a state in which the upstream-end opening of the ink flow passage 15d is opened to cause the internal pressure of the pump chamber 31a to become lower than that of the pressure chamber 32a. Therefore, ink flows rapidly with a great force at the time of the opening of the ink flow passage 15 due to negative pressure that is applied from the downstream side of the ink flow passage 15.

The foregoing exemplary embodiment of the invention may be modified as follows.

A one-way valve having other non-return valve structure may be used as a substitute for the ball valve 39. For example, a valve like the one-way valve 41 may be used.

The first displacement portion 37 may have a projection like the projection 36b. The first displacement portion 37 having a projection functions as a one-way valve that gets into a valve-closed state when the pump 43 is driven for suction. When such a modified structure is adopted, the ball valve 39 can be omitted.

A driving source for driving the pump 43 and a driving source for causing the second displacement portion 38 to be displaced forcibly in choke cleaning may be provided as two discrete driving sources, which are separated from each other. In such a modified configuration, the pump 43 may be pressurized when it is driven.

The pressurization of the internal space of the first air chamber 34a and the depressurization (i.e., pressure reduction) thereof may be repeated alternately for driving the pump 43. Or, a piston, which is an example of a first displacement portion, may be moved in reciprocating motion for driving the pump 43. In such a modified configuration, it is not necessary to provide the coil spring 42 as an example of an urging member.

It is not always necessary to release a choked state at a point in time at which suction driving of the pump 43 ends as long as an ink flow space is secured inside the pump chamber 31a, for example, with direct communication of the ink flow passage 15b and the ink flow passage 15c with each other. For example, the first displacement portion 37 may be positioned at the bottom dead point in the opening step.

An extension spring may be used as a substitute for a compression spring for the coil springs 40 and 42, each of which is an example of an urging member.

It is not always necessary to adopt the airflow passage 45 whose front-end side branches into three passages. For example, an airflow passage through which the negative pressure generation device 44 is connected to the first air chamber 34a and an airflow passage through which the negative pressure generation device 44 is connected to the second air chamber 35a may be separated from each other. Or, the first air chamber 34a and the second air chamber 35a may be in communication with each other.

A negative pressure generation device and another negative pressure generation device, which are driven with a time difference therebetween, may be connected to the first air chamber 34a and the second air chamber 35a, respectively.

The flow passage extension portion 47 is not limited to a meandering flow passage. The flow passage extension portion 47 may have any other form. For example, the flow passage extension portion 47 may be a spiral flow passage.

A means for making the flow-passage resistance of the branch airflow passage 45b larger than that of the branch airflow passage 45a is not limited to the flow passage extension portion 47. For example, an obstacle such as a filtering member may be provided somewhere on the branch airflow passage 45b. With an obstacle being provided on the branch airflow passage 45b, the flow-passage resistance of the branch airflow passage 45b is larger than that of the branch airflow passage 45a due to pressure loss.

A communicating medium that communicates a pressure variation to the first displacement portion 37 and the second displacement portion 38 is not limited to air. For example, liquid such as oil may flow in a variable pressure chamber and a pressure reduction chamber.

An ink-jet printer is taken as an example of a fluid ejecting apparatus in the foregoing description of an exemplary embodiment of the invention. However, the scope of the invention is not limited to an ink-jet printer. The invention can be applied to various liquid ejecting apparatuses that eject or discharge various kinds of liquid that includes ink but not limited thereto. It can be applied to various micro-drop liquid ejecting apparatuses that are provided with micro-drop liquid ejecting heads for discharging liquid drops whose amount is very small. Herein, a “liquid drop” is a form or a state of liquid in the process of ejection of the liquid from a liquid ejecting apparatus. The liquid drop encompasses, for example, a particulate drop, a tear-shaped drop, and a viscous/thready drop that forms a thread tail, without any limitation thereto. The “liquid” may be made of any material as long as a liquid ejecting apparatus can eject it. The liquid may be any substance as long as it is in a liquid phase. It may have high viscosity or low viscosity. It may be sol or gel water. Or, it may be fluid that includes, without any limitation thereto, inorganic solvent, organic solvent, solution, liquid resin, and liquid metal (e.g., metal melt). The “liquid” is not limited to liquid as a state of a substance. It encompasses a liquid/liquefied matter/material that is made as a result of dissolution, dispersion, or mixture of particles of a functional material made of a solid such as pigment, metal particles, or the like into/with a solvent, though not limited thereto. Besides ink explained in the foregoing exemplary embodiment, liquid crystal is a typical example of the liquid. The term “ink” encompasses various types of ink having various liquid compositions such as popular water-based ink, oil-based ink, gel ink, hot melt ink, or the like. Examples of various liquid ejecting apparatuses are: an apparatus that ejects liquid in which, for example, a material such as an electrode material, a color material, or the like that is used in the production of a liquid crystal display device, an organic EL (electroluminescence) display device, a surface/plane emission display device, a color filter, or the like is dispersed or dissolved, an apparatus that ejects a living organic material that is used for production of biochips, an apparatus that is used as a high precision pipette and ejects liquid as a sample, a textile printing apparatus, a micro dispenser, and the like. In addition, the invention is applicable to and can be embodied as a liquid ejecting apparatus that ejects, with high precision, lubricating oil onto a precision instrument and equipment including but not limited to a watch and a camera. Moreover, the invention is applicable to and can be embodied as a liquid ejecting apparatus that ejects liquid of a transparent resin such as an ultraviolet ray curing resin or the like onto a substrate so as to form a micro hemispherical lens (optical lens) that is used in an optical communication element or the like. Furthermore, the invention is applicable to and can be embodied as a liquid ejecting apparatus that ejects an etchant such as acid or alkali that is used for the etching of a substrate or the like. Without any intention to limit the technical scope of the invention to those enumerated or explained above, the invention can be applied to various ejecting apparatuses that eject or discharge various kinds of fluid such as those enumerated or explained above.

What is claimed is:

1. A fluid supplying apparatus comprising:
a fluid supplying passage through which fluid is supplied from a fluid supplying source, which is provided at an upstream side, toward a downstream side;
a pump that is driven for pumping operation, the pump including a pump chamber and a first displacement portion, the pump chamber being formed as a part of the fluid supplying passage, the first displacement portion being able to become displaced in such a way as to increase or decrease capacity of the pump chamber to drive the pump;
a closing device that closes the fluid supplying passage, the closing device including a pressure chamber and a second displacement portion, the pressure chamber being formed as a part of the fluid supplying passage at a downstream position viewed from the pump chamber, the second displacement portion being able to become displaced in such a way as to increase or decrease capacity of the pressure chamber, the second displacement portion being displaced in a direction for decreasing the capacity of the pressure chamber in accordance with negative pressure that is applied from the downstream side of the fluid supplying passage to close the fluid supplying passage;
a pressure reduction chamber that is formed next to the pressure chamber and is partitioned from the pressure chamber with the second displacement portion being formed as a partition between the pressure reduction chamber and the pressure chamber; and
an opening device that opens the fluid supplying passage, the opening device reducing internal pressure of the pressure reduction chamber, the opening device applying negative pressure to the second displacement portion as a result of pressure reduction to cause the second displacement portion to be displaced in a direction for increasing the capacity of the pressure chamber to open the fluid supplying passage.

2. The fluid supplying apparatus according to claim 1, wherein:
the pump further includes a variable pressure chamber that is formed next to the pump chamber and is partitioned from the pump chamber with the first displacement portion being formed as a partition between the variable pressure chamber and the pump chamber; and
the opening device reduces internal pressure of the variable pressure chamber to cause the first displacement portion to be displaced in a direction for increasing the capacity of the pump chamber to suck the fluid into the pump chamber, which is suction operation of the pump.

3. The fluid supplying apparatus according to claim 2, wherein:
the opening device reduces the internal pressure of the variable pressure chamber through a first flow passage through which the opening device is connected to the variable pressure chamber;
the opening device reduces the internal pressure of the pressure reduction chamber through a second flow passage through which the opening device is connected to the pressure reduction chamber; and
flow passage resistance of the second flow passage is larger than that of the first flow passage.

4. A fluid ejecting apparatus comprising:
a fluid ejecting head that ejects fluid; and
the fluid supplying apparatus according to claim 1, which supplies the fluid from the fluid supplying source toward the fluid ejecting head.

5. The fluid ejecting apparatus according to claim 4, wherein:
the pump of the fluid supplying apparatus further includes a variable pressure chamber that is formed next to the pump chamber and is partitioned from the pump chamber with the first displacement portion being formed as a partition between the variable pressure chamber and the pump chamber; and
the opening device reduces internal pressure of the variable pressure chamber to cause the first displacement portion to be displaced in a direction for increasing the capacity of the pump chamber to suck the fluid into the pump chamber, which is suction operation of the pump.

6. The fluid ejecting apparatus according to claim 5, wherein:
the opening device reduces the internal pressure of the variable pressure chamber through a first flow passage through which the opening device is connected to the variable pressure chamber;
the opening device reduces the internal pressure of the pressure reduction chamber through a second flow passage through which the opening device is connected to the pressure reduction chamber; and
flow passage resistance of the second flow passage is larger than that of the first flow passage.

7. A fluid supplying method for supplying fluid through a fluid supplying passage from a fluid supplying source, which is provided at an upstream side, toward a downstream side, the fluid being supplied as a result of operation of a pump that includes a pump chamber and a first displacement portion, the pump chamber being formed as a part of the fluid supplying passage, the first displacement portion being able to become displaced in such a way as to increase or decrease capacity of the pump chamber to drive the pump, the fluid supplying method comprising:
closing the fluid supplying passage as a result of operation of a pressure chamber and a second displacement portion, the pressure chamber being formed as a part of the fluid supplying passage at a downstream position viewed from the pump chamber, the second displacement portion being able to become displaced in such a way as to increase or decrease capacity of the pressure chamber, the second displacement portion being displaced in a direction for decreasing the capacity of the pressure chamber in accordance with negative pressure that is applied from the downstream side of the fluid supplying passage to close the fluid supplying passage; and
opening the fluid supplying passage by reducing internal pressure of a pressure reduction chamber that is formed next to the pressure chamber and is partitioned from the pressure chamber with the second displacement portion being formed as a partition between the pressure reduction chamber and the pressure chamber and applying negative pressure to the second displacement portion as a result of pressure reduction to cause the second displacement portion to be displaced in a direction for increasing the capacity of the pressure chamber while suppressing the displacement of the first displacement portion in a direction for increasing the capacity of the pump chamber to open the fluid supplying passage.
